(19) United States
(12) Patent Application Publication
(10) Pub. No.: US 2008/0309160 A1
(43) Pub. Date: Dec. 18, 2008

(54) Modular blade enclosure power subsystem disign

(75) Inventors: Gregory L. Gibson, The Woodlands, TX (US); David W. Sherrod, Tornball, TX (US); Jonathan E. JamesOu, Sugarland, TX (US); Scott Stephenson, Manvel, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L. P.

(21) Appl. No.: 12/153,742

(22) Filed: May 23, 2008

Related U.S. Application Data
(60) Provisional application No. 60/943,973, filed on Jun. 14, 2007.

(51) Int. Cl. H02J 3/00; H02J 1/00

(52) U.S. Cl. 307/11

(57) ABSTRACT

An apparatus for distributing power to computing modules in a multi module enclosure. The apparatus includes at least one power input module, a plurality of power input cables, a plurality of power conversion modules, and a plurality of computing modules. The at least one power input module is modularly arranged within the multi module enclosure. The plurality of power input cables are electrically connected to and provide power input to the at least one power input module. The plurality of power conversion modules are electrically connected to power outputs of the at least one power input module and are modularly arranged within the multi module enclosure. The plurality of computing modules are electrically connected to power outputs of the power conversion modules and are arranged within the multi module enclosure.

### CROSS-REFERENCE TO RELATED PATENT APPLICATIONS

This application claims priority from Provisional Application U.S. Application 60/943,973, filed Jun. 14, 2007, incorporated herein by reference in its entirety.

### BACKGROUND OF THE INVENTION

The present invention relates generally to the field of enclosure power subsystems.

A server typically comprises a number of modules, such as server blade, switch, fan and enclosure management modules. These modules require power, which is supplied from a power subsystem, which converts power from facility power where the server modules are disposed, to the modules. The power subsystem typically comprises a power input module, which is electrically connected to the AC power of the facility in the 100V to 250 V range. The power input module provides AC power to one or more power conversion modules, which convert the AC power to DC power to be provided to power using modules, such as server blade, switch, fan and enclosure management modules, of the server. The power subsystem, however, is generally a fixed power supply system that only offers a customer one choice of power access per unit.

### SUMMARY OF THE INVENTION

According to one embodiment of the invention, there is provided an apparatus for distributing power to computing modules in a multi module enclosure. The apparatus comprises: a plurality of input cables electrically connected to, an enclosure power input module electrically connected to, a plurality of hot plug power conversion modules electrically connected to, the plurality of computing modules. According to another embodiment of the invention, there is provided an apparatus for distributing power to computing modules in a multi module enclosure. The apparatus comprises: at least one power input module modularly arranged within the multi module enclosure; a plurality of power input cables electrically connected to and providing power input to the at least one power input module; a plurality of power conversion modules electrically connected to power outputs of the at least one power input module and modularly arranged within the multi module enclosure; and a plurality of computing modules electrically connected to power outputs of the power conversion modules.

According to another embodiment of the invention, there is provided an apparatus for distributing power to computing modules in a multi module enclosure. The apparatus comprises: at least one AC power input module modularly arranged within the multi module enclosure; a plurality of power input cables electrically connected to and providing AC power input to the at least one AC power input module; a plurality of AC to DC power conversion modules electrically connected to power outputs of the at least one AC power input module and modularly arranged within the multi module enclosure; a plurality of computing modules electrically connected to power outputs of the AC to DC power conversion modules.

### BRIEF DESCRIPTION OF THE DRAWINGS

FIG. 1 is a schematic illustrating an apparatus for distributing power within a multi-module enclosure according to an embodiment of the invention.

FIGS. 2A and 2B are internal cables of a power input module according to embodiments of the invention.

FIGS. 3A, 3B and 3C are a front view, side view and back view, respectively, of a power input module according to an embodiment of the invention.

FIGS. 4A, 4B and 4C are a front view, side view and back view, respectively, of a power input module according to another embodiment of the invention.

FIGS. 5A and 5B are a front view and a side view, respectively, of a power input module according to another embodiment of the invention.

FIGS. 6A and 6B are a front view and a side view, respectively, of a power input module according to another embodiment of the invention.

FIG. 7 is a top perspective view of a power conversion module and power input module according to an embodiment of the invention.

FIG. 8 is a top perspective view of the power conversion module and power input module of FIG. 7 in combination with a DC power PCA (printed circuit assembly) according to an embodiment of the invention.

FIG. 9 is a top perspective view of the power conversion module and power input module of FIG. 7 in combination with a DC power PCA and DC power distribution assembly according to an embodiment of the invention.

FIG. 10 is a top perspective view of the power conversion module and power input module of FIG. 7 in combination with a DC power PCA, DC power distribution assembly, and computing module according to an embodiment of the invention.

FIGS. 11A and 11B are a front perspective view and back perspective view of a multi-module enclosure with computing module, power input module and power conversion module according to an embodiment of the invention.

FIG. 12A is a back perspective view of the arrangement of FIGS. 11A and 11B with the power input module removed from the multi-module enclosure.

FIG. 12B is a back perspective view of the arrangement of FIGS. 11A and 11B with the power input module and power conversion module removed from the multi-module enclosure.

### DETAILED DESCRIPTION OF THE PREFERRED EMBODIMENTS

The present inventors have realized that it can be costly to have different dedicated enclosure designs to support all the different types of facilities power environments. Further, in the case of a server computer system, it is very desirable to have the power subsystem reside within the same enclosure as the computing modules of the server, such as the server blades, switches, fans, and enclosure management modules, as compared to external solutions, where the power subsystem is not within the same enclosure. Thus, the present inventors have contemplated a modularized power subsystem design, with removable power input modules and power conversion modules, such as hot plug power supplies. Such a modular design provides tremendous flexibility at minimal cost. The modularized approach overcomes problems with prior power subsystem solutions which have generally been fixed power supply systems that only offer a customer one choice of power access per unit.

For facilities with AC power in the 100V-250V range, the modular approach allows for multiple types of power input modules to be used to match the customer's facilities power to a server blade enclosure with a matching AC to DC hot plug power conversion module. The design allows for use with power input modules supporting single phase AC, North America 3 Phase AC, and International 3 Phase all with one common power conversion module design. With such modular design an appropriate input power module may be readily swapped into the system and connected to the power conversion modules according to the facility AC power details.

This modular design is capable of supporting 48V or other Facility DC power merely by changing the power input module, and power conversion module if necessary, as appropriate. Further, this design is capable of supporting other future power distribution technologies such as high voltage facilities DC simply by exchanging the power input, and power conversion modules if necessary, with modules that are designed for that particular application.

Preferably, the power subsystem modules reside within the same enclosure as all of the computing module blade system equipment such as server blades, switches, fans, and management modules. Power flows from the available facilities power line to the enclosure power input module to the power conversion module, such as a hot plug power supply, to an electrical connector, such as a fixed DC enclosure common power backplane, which then distributes power to each of the computing modules installed in the enclosure.

The sizes of the power input modules and power conversion module designs can change to meet additional facility power topologies available today and in the future without changing the blade enclosure design.

The modular design allows the factory to configure the power subsystem of the multi module enclosure as one of the last steps in the assembly process to match the orders made by customers to support their facilities power environment. The design allows the blade enclosure to easily be re-configured in the factory if necessary due to a canceled order or other reasons. The design allows the design team and factory to quickly implement support for new power distribution technologies with no impact to the blade enclosure chassis, servers, switches, fans, or enclosure management hardware. The design allows the customer to have their blade enclosures upgraded at a later time to support different or future facility power solutions.

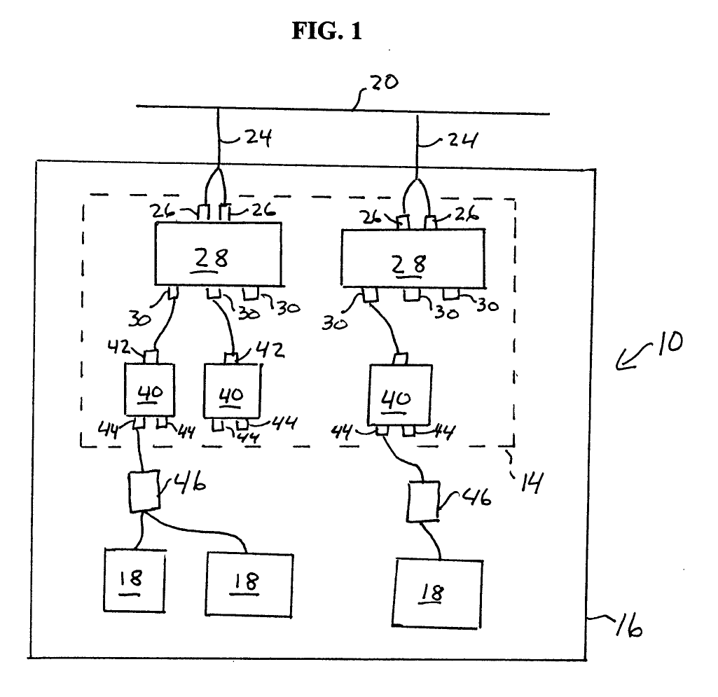

FIG. 1 illustrates an apparatus, in schematic form, for distributing power within a multi-module enclosure according to an embodiment of the invention. The multi-module apparatus 10 of FIG. 1 includes a multi-module enclosure 16 or chassis which encloses a power subsystem 14 and a plurality of computing modules 18. The multi-module apparatus 10 may be a computer server system, for example. The multi-module enclosure 16 may be a metal enclosure, and may have a shape as appropriate, such as a box shape with rectangular cross-section. A facility power line 20 provides power, such as AC power, to the power subsystem 14, which in turn provides power, such as DC power, to the computing modules 18. The computing modules 18 may be server blades, switches, fans, management modules, for example, of the apparatus which require power to perform various functions.

The facility power line 20 is electrically connected to the multi-module apparatus via power input cables 24. Specifically, the power input cables electrically connect to power inputs 26 of at least one power input module 28 of the power subsystem 14. The power input modules 28 convert the power received at the power inputs 26 to power to be supplied at the power outputs 30 for use by the power conversion modules 40 of the power subsystem. If the facility power line 20 provides AC power, the power input modules 28 supply AC power at the power outputs 30. The power input module 28 may be an AC 120 volt module, an AC 240 volt module, or a DC module, for example.

The power conversion modules 40 are electrically connected to the power input modules 28, such as by the power outputs 30 of the power input modules 28 connected to power inputs 42 of the power conversion modules 40. The power conversion modules 40 convert the power received from the power input modules 28 to power to be used by the computing modules. For example, the power conversion modules may be AC to DC power conversion modules that convert AC power to DC power to be used by the computing modules 18. The power conversion modules 40 may be hot plug power supplies, for example. The power conversion modules 40 supplies power at the power outputs 44 of the power conversion modules 40.

The computing modules 18 are electrically connected to the power conversion modules 40 via electrical connectors 46 which connect between the power outputs 40 and the computing modules 18. The electrical connectors 46 properly distribute DC power to one or more respective computing modules 18 connected thereto. The electrical connectors 46 may comprise a DC power PCA, for example, and a DC power distribution assembly, such as a power back plane, for example, for connecting to a respective computing module.

The multi-module apparatus 10 as illustrated in FIG. 1 has two power input modules 28. In general, the number of power input modules 28 may be at least one, and may be more than two. Further, the multi-module apparatus 10 as illustrated in FIG. 1 has three power conversion modules 40 and three computing modules 18. In general, the number of power conversion modules 40 and computing modules 18 will depend on the particular application, and may be at least one of each of the power conversion modules 40 and computing modules 18. The number of power outputs and power inputs for the power input modules 28 and power conversion modules 40 will also depend on the application and may be one or more.

Each power input module 28 may also have a rectangular cross-section metal enclosure, such as by way of example, having dimensions of approximately 64 mm×430 mm×33 mm. The power outputs 30 of each power input module 28 may comprise floating AC output connectors, such as six such output connectors, which mate with the inputs 42 of the power conversion modules 40. The power inputs 24 of each power input module 28 may comprise AC inputs which include 6 single phase 208V C20 plugs for individual power cords, or alternatively for example, 2 mounted, 3 phase, 208V power cords. Specially arranged wiring internally controls the AC input feed to the proper output connector per power supply.

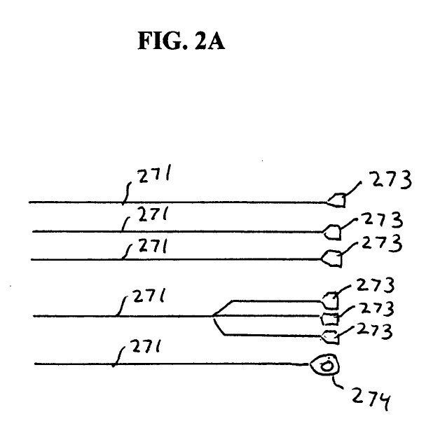

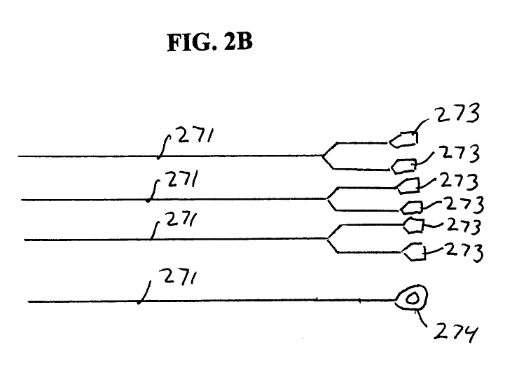

FIG. 2A to FIG. 12B illustrate various components of the multi module apparatus, alone, and in various combinations.

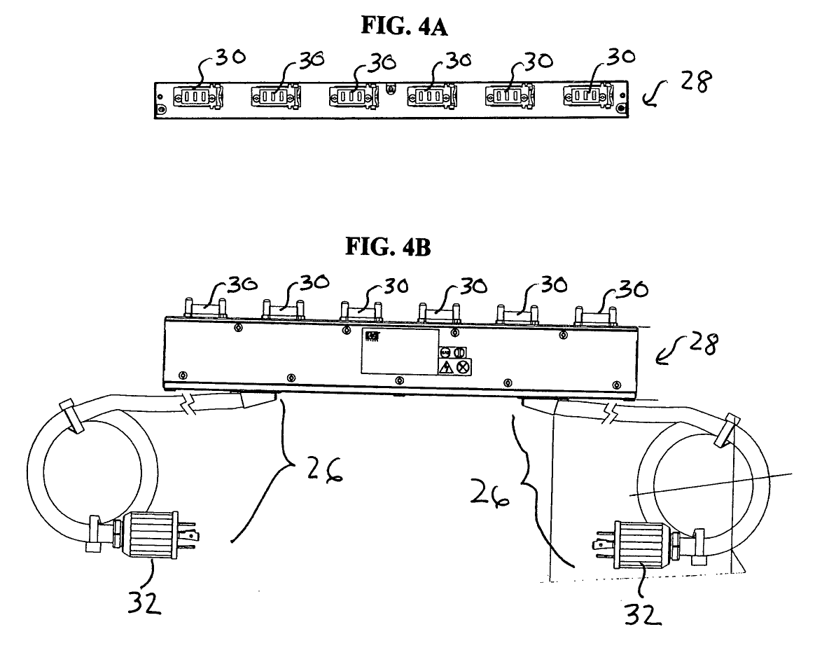

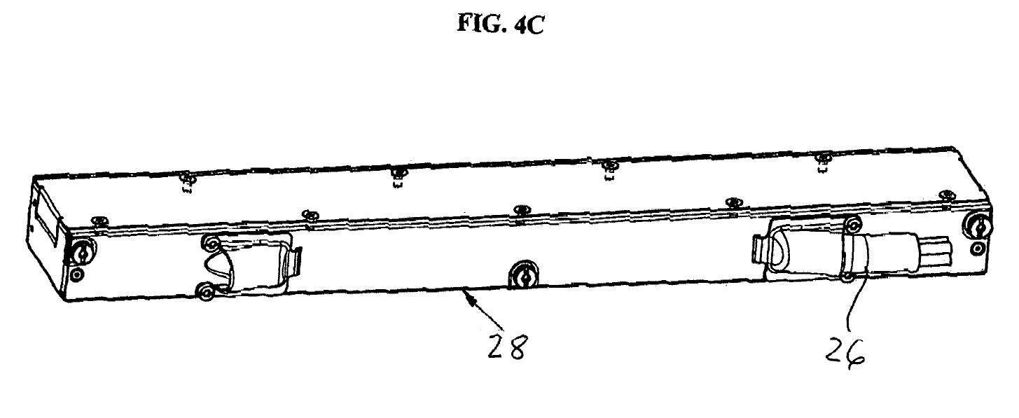

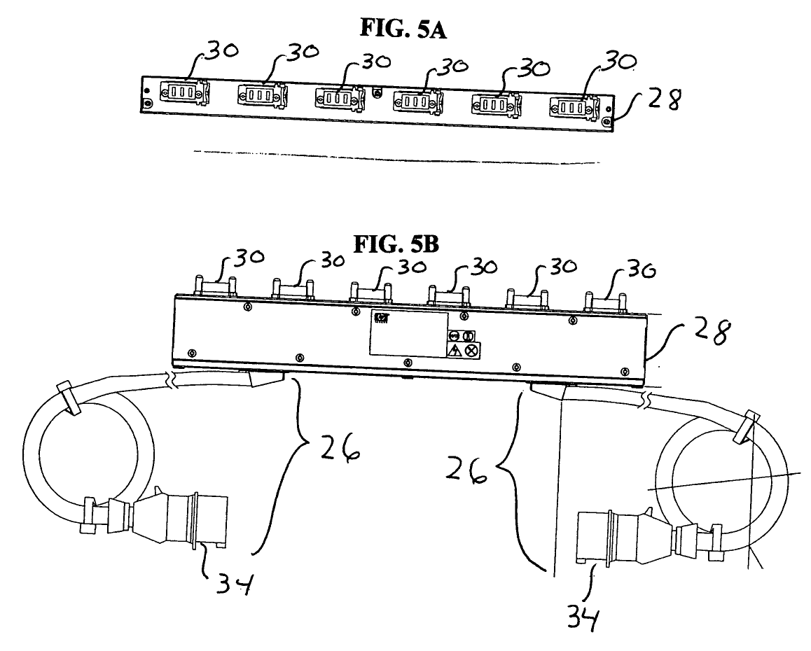

FIGS. 2A and 2B are schematics illustrating internal wiring 27 for power input modules 28. The particular cables used depends upon the application, and in particular the specific configuration of the power inputs 26 and power outputs described below. The internal cables include wires 271 and terminals 273 and 274. In particular, FIG. 2A illustrates the internal wiring for an international 3-phase input (See FIGS. 5A and 5B), while FIG. 2B illustrates the internal wiring for an domestic (North American) 3-phase input (See FIGS. 4A-4C)

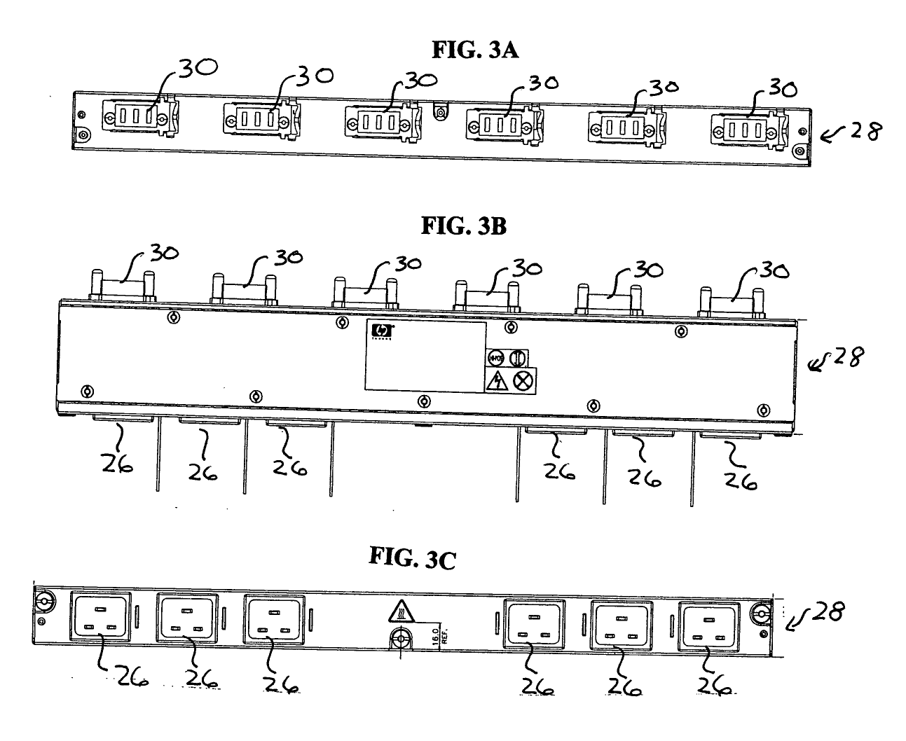

FIGS. 3A, 3B and 3C illustrate a power input module 28 according to one embodiment of the invention, where 3A illustrates a front view, 3B a side view, and 3C a back view. The power outputs 30 may comprise 6 floating AC connectors, while the power inputs 26 may comprise 6 single phase plugs, such as 208V C20 plugs, for example, which may mate with individual power cords.

FIGS. 4A, 4B and 4C illustrate a power input module 28 according to another embodiment of the invention, where 4A illustrates a front view, 4B a side view, and 4C a back perspective view. The power outputs 30 in this embodiment may comprise 6 floating AC connectors, while the power inputs 26 may comprise 2 mounted, 3 phase power cords, such as 208V power cords, for example, with a domestic 3 phase connector 32. FIG. 4C illustrates one of the power cords removed from the input module 28 for the purposes of illustration.

FIGS. 5A and 5B illustrate a power input module 28 according to another embodiment of the invention, where 5A illustrates a front view, and 5B a side view. The embodiment of FIGS. 5A and 5B is similar to that of the embodiment of FIGS. 4A and 4B, except that in the embodiment of FIGS. 5A and 5B, the connector on the power cord is an international connector 34 instead of a domestic 3 phase connector.

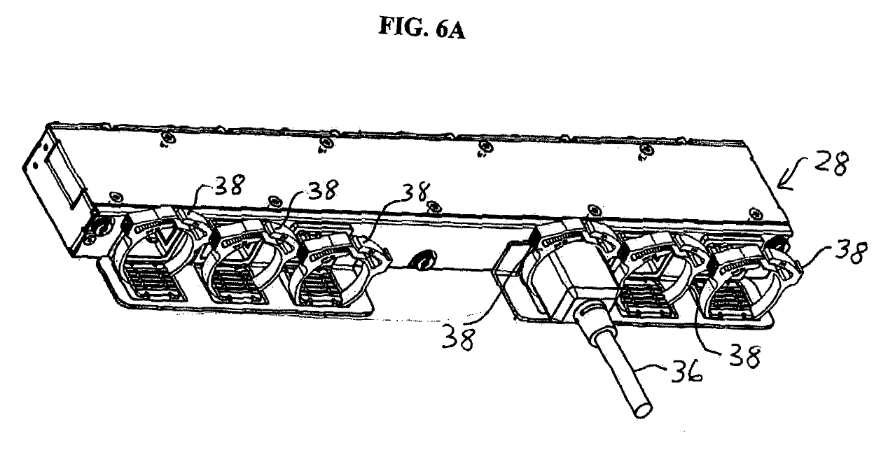

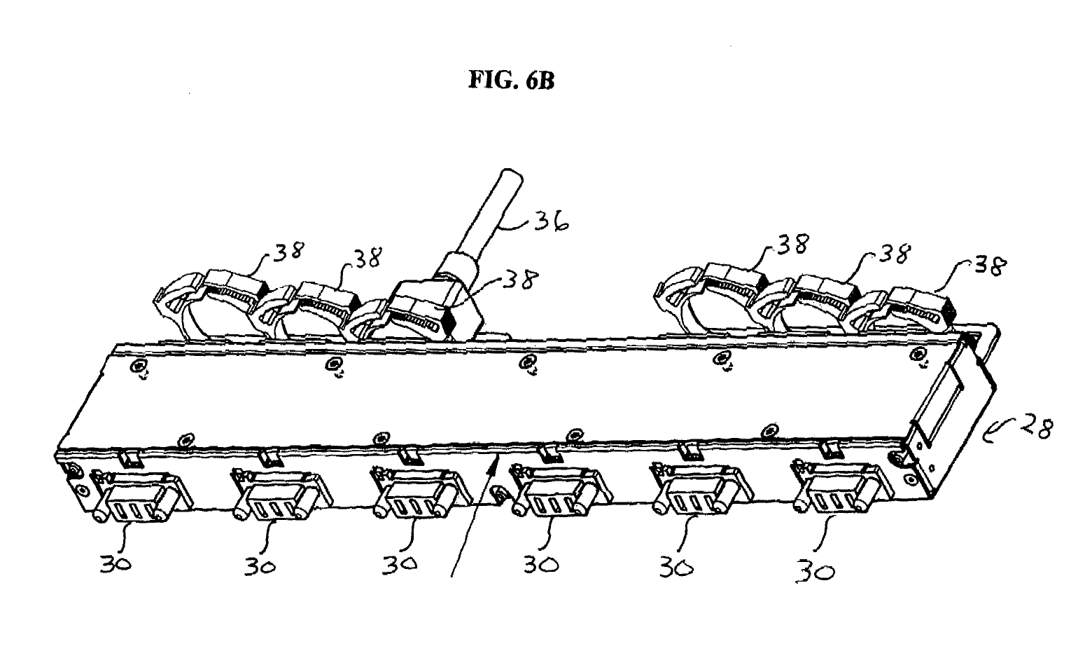

FIGS. 6A and 6B illustrate a power input module 28 according to another embodiment of the invention, where 6A illustrates a back perspective view, and 6B a front perspective view. The power outputs 30 may comprise 6 floating AC connectors, while the power inputs 26 may comprise 6 single phase plugs for connecting to respective power cords 36. The power input module 28 also includes power cord retention devices 38 which may be tightened to retain the respective power cords, when the power cords 36 are mated with the single phase plugs. The retention devices 38 provides strain relief for the power cords 36.

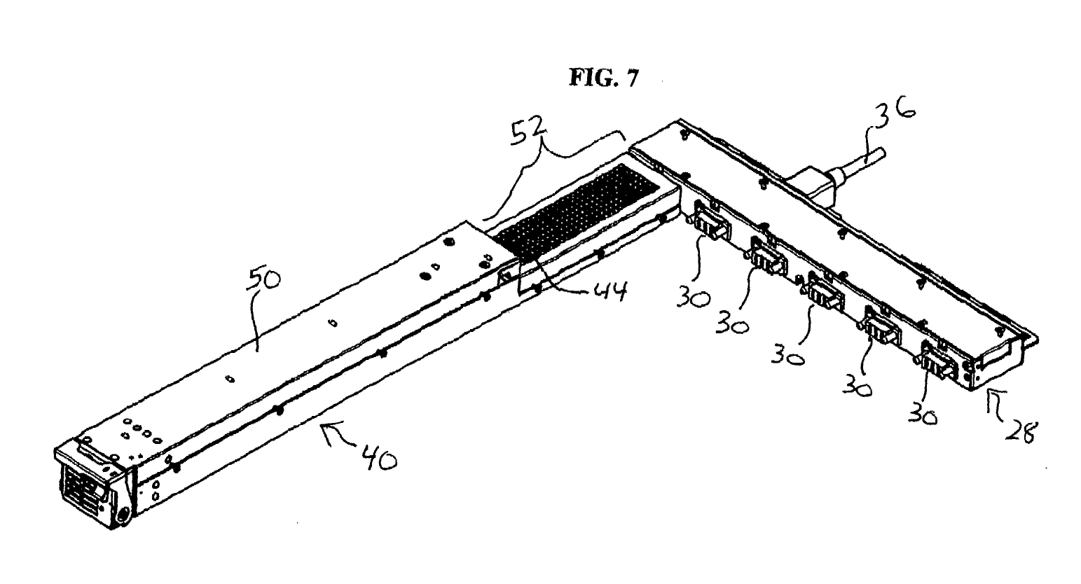

FIG. 7 illustrates a power conversion module 40 electrically connected to a power input module 28. The conversion module 40 may be a hot plug power supply, for example. The power conversion module 40 includes a rectangular cross-section metal enclosure 50, such as by way of example, having dimensions of approximately 55.63 mm×68.83 mm×705.10 mm. The power outputs 44 of the power conversion module 40 may be a DC power output connector located approximately 500 mm, for example, from the front of the module 40. The power input 42 may be an AC power input connector (not seen in FIG. 7) located at the rear of the power conversion module 40 connected to one of the power outputs 30 of the power input module 28. The power conversion module 40 has an area of reduced height 52 after a distance of approximately 508 mm from the front Bezel of the power conversion module 40 where the power conversion module height is relatively reduced, for example, to about approximately 33 mm.

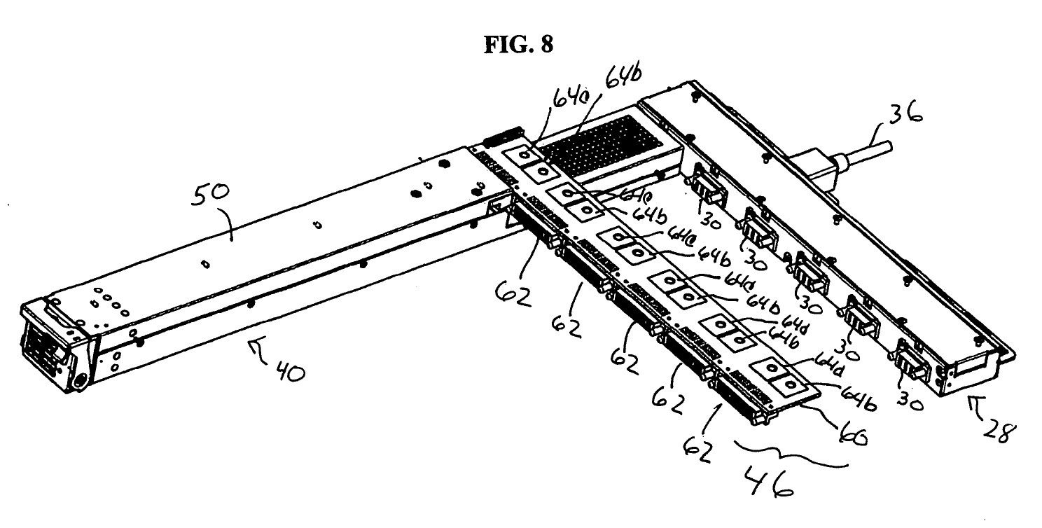

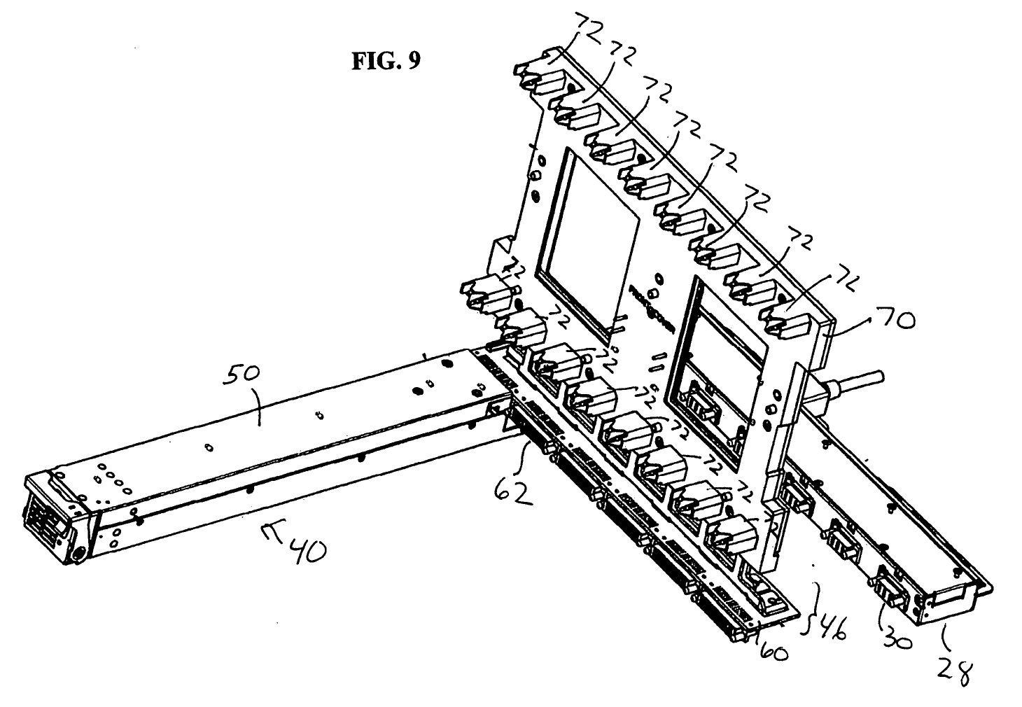

FIGS. 8 and 9 illustrate an electrical connector 46 electrically connected to a power conversion module 40, which in turn is electrically connected to a power input module 28. The arrangement of the power conversion module 40 and the power input modules 28 in FIG. 7 is the same as in FIGS. 8 and 9. The electrical connector 46 comprises a DC power PCA 60 and a DC power distribution assembly 70. The DC power PCA 60 and DC power distribution assembly 70 provide power distribution from the power conversion module 40 to one or more computing modules 18. The power outputs 44 of the power conversion module 40 connect to respective DC PCA connectors 62 of the power conversion module 40. The DC power PCA 60 has a pairs of connection pads 64a and 64b, which may be copper for example, for electrically connecting to the DC power distribution assembly 70. The DC power distribution assembly 70 has DC power connectors 72 for electrically connecting to respective computing modules 18, and providing DC power thereto.

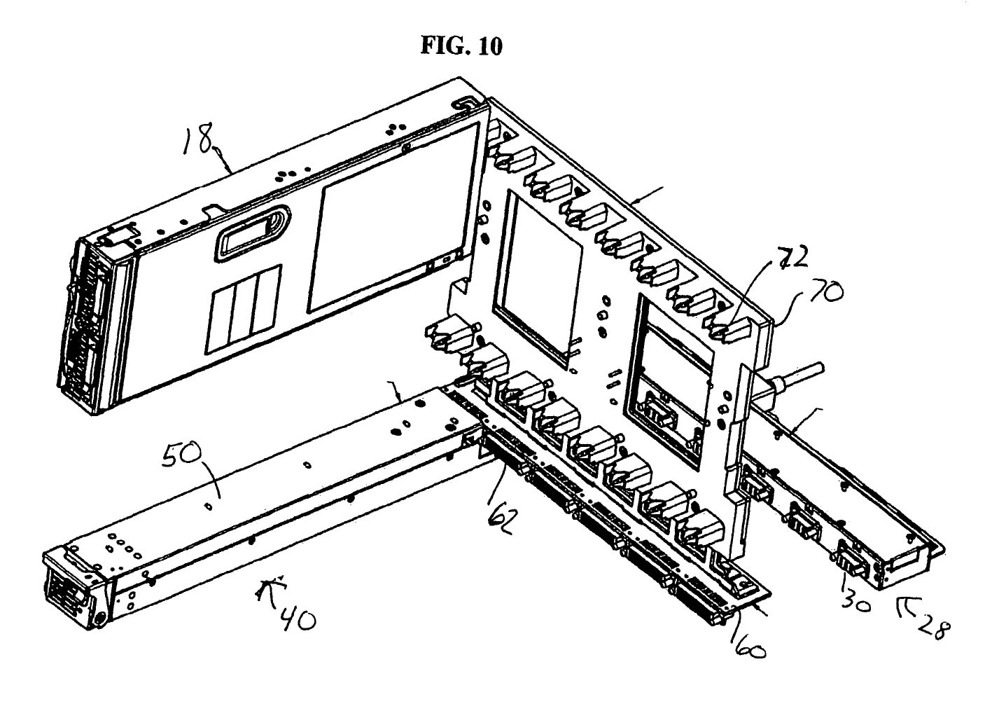

FIG. 10 illustrates the arrangement of FIG. 9, with a computing module 18. The computing module 18 may be electrically connected to the DC power distribution assembly 70 at the DC power connectors 72 to provide DC power to the module 18 as noted above. The module 18 may be a server blade as shown in FIG. 10, or some other type of module.

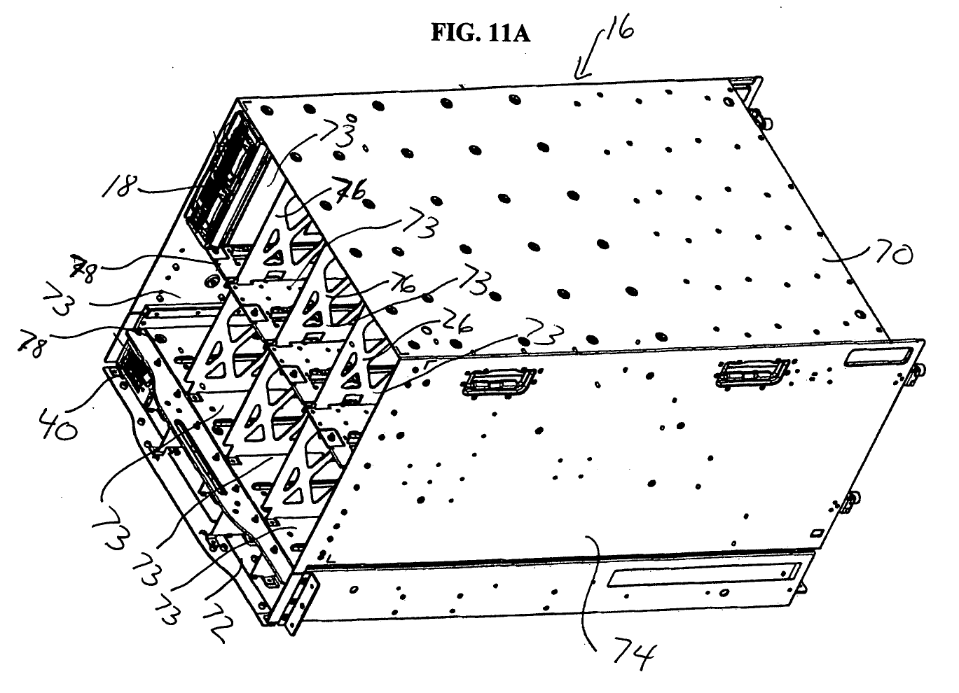

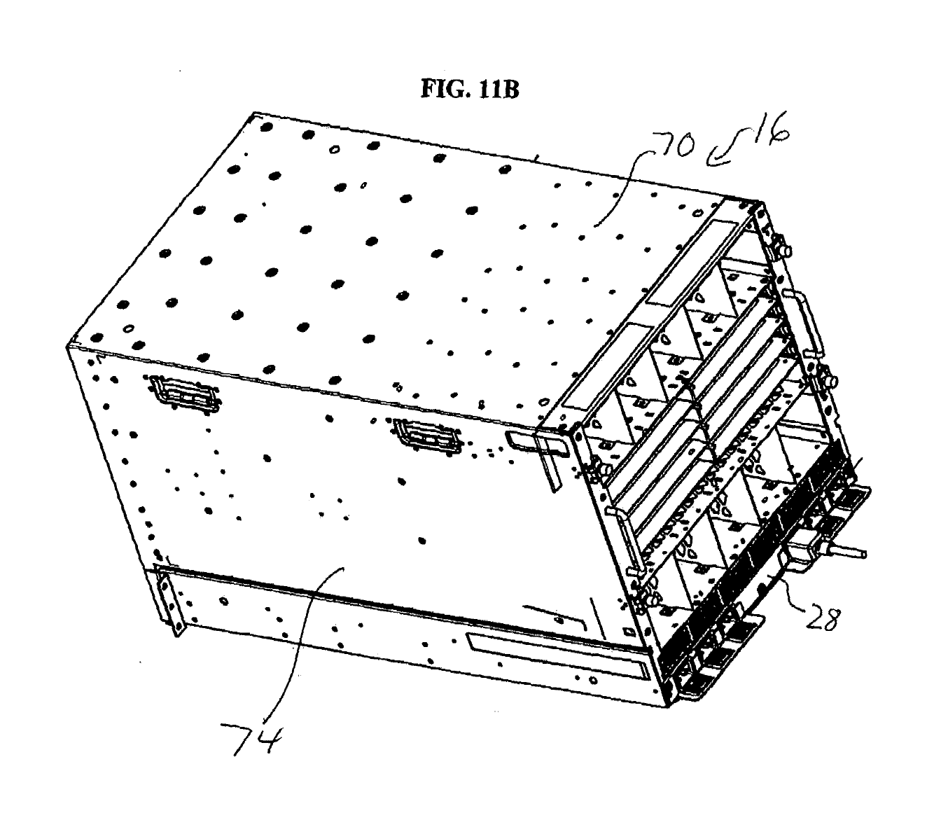

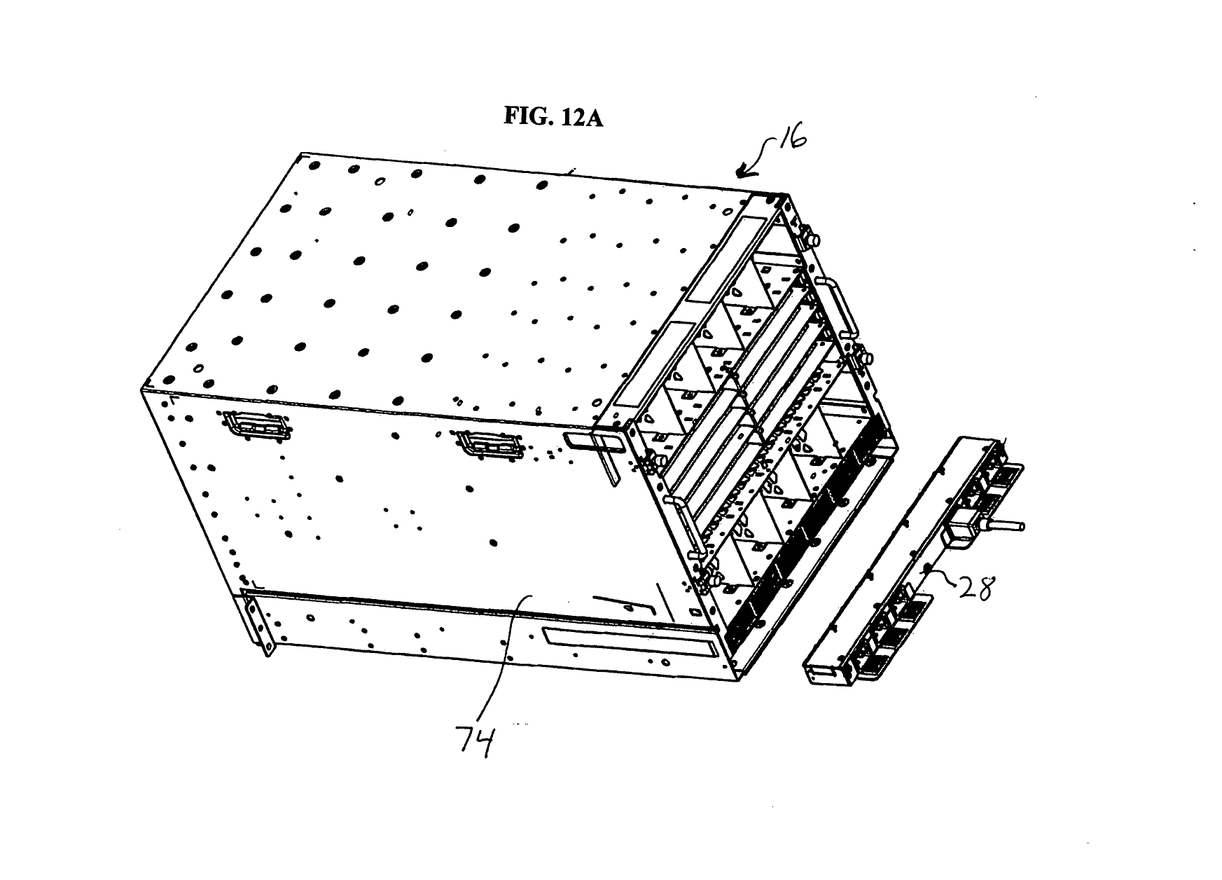

FIGS. 11A and 11B illustrate a multi-module enclosure 16 with computing module 18, power conversion module 40 and power input module 28 enclosed therein. FIGS. 11A and 11B illustrate a front perspective view and back perspective view, respectively. The multi-module enclosure 16 comprises a top wall 70, side walls 74 and bottom wall 72 defining a generally box shape. The computing module 18, power conversion module 40 and power input module 28 are enclosed within the top wall 70, side walls 74 and bottom wall 72.

The multi-module enclosure 16 also includes a number of vertical inner walls 76 and horizontal inner walls 78 extending within the multi-module enclosure 16 to provide support for any computing modules 18 within the enclosure 16. The vertical inner walls 76 and horizontal inner walls 78 may extend in a grid like fashion, for example, defining a number of cells 73. In general, the inner walls 76 and 78 will provide support for multiple modules 18. The multiple modules 18 may be connected to a single DC power distribution assembly (See FIG. 10). The enclosure 16 in FIG. 11A shows 8 cells, where 2 computing modules may be accommodated within each cell. In general, the number of cells may be any number as appropriate.

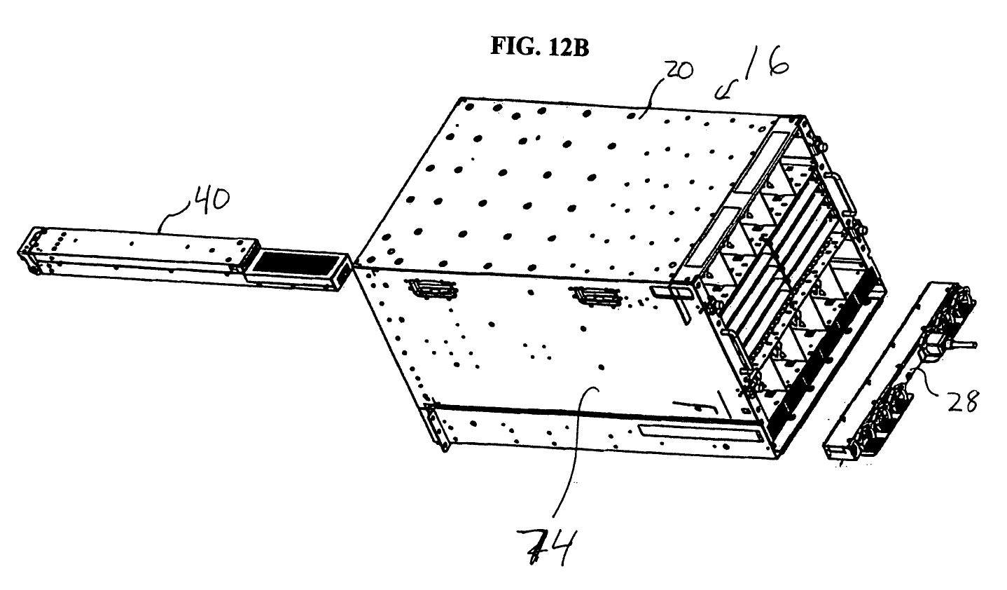

FIGS. 12A and 12B illustrate the design of FIG. 11B with the power input module 28, and the power input module 28 and power conversion module 44, respectively, removed from the multi-module enclosure 16. The power input module 28 and the power conversion module are removably attached to each other and to the multi-module enclosure 16.

The modularized power subsystem design as described above provides great flexibility in design. Computing modules may be readily replaced and upgraded, and appropriate power input and power conversion modules swapped in and out as module power needs, and/or facility power lines change. Additionally, the design allows the power input module, power conversion module, and computing modules to be housed within a single enclosure in a compact manner.

Any flow diagrams presented are in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. Apparatus for distributing power to computing modules in a multi module enclosure comprising:
a plurality of input cables electrically connected to,
an enclosure power input module electrically connected to,
a plurality of hot plug power conversion modules electrically connected to,
the plurality of computing modules.

2. An apparatus as in claim 1 wherein said enclosure power input modules are AC 120 volt modules.

3. An apparatus as in claim 1 wherein said enclosure power input modules are AC 240 volt modules.

4. An apparatus as in claim 1 wherein said enclosure power input modules are DC modules.

5. An apparatus for distributing power to computing modules in a multi module enclosure comprising:
at least one power input module modularly arranged within the multi module enclosure;
a plurality of power input cables electrically connected to and providing power input to the at least one power input module;
a plurality of power conversion modules electrically connected to power outputs of the at least one power input module and modularly arranged within the multi module enclosure; and
a plurality of computing modules electrically connected to power outputs of the power conversion modules and arranged within the multi module enclosure.

6. The apparatus as in claim 5, wherein the at least one power input module is an AC 120 volt module.

7. The apparatus as in claim 5, wherein the at least one power input module is an AC 240 volt module.

8. The apparatus as in claim 5, wherein the at least one power input module is a DC module.

9. The apparatus as in claim 5, wherein the at least one power input module comprises a plurality of single phase power inputs.

10. The apparatus as in claim 5, wherein the at least one power input module comprises at least one three-phase power input.

11. The apparatus as in claim 5, wherein the computing modules comprise at least one of server blades, switches, fans, or management modules.

12. The apparatus as in claim 5, wherein the power conversion modules comprise AC to DC power conversion modules.

13. The apparatus as in claim 5, wherein at least one of the power conversion modules comprises a power supply.

14. The apparatus as in claim 13, further comprising a DC power PCA electrically connected to the power supply.

15. The apparatus as in claim 14, further comprising a DC power distribution assembly electrically connected to the DC power PCA.

16. The apparatus as in claim 15, wherein at least one of the computing modules is electrically connected to the DC power distribution assembly.

17. The apparatus as in claim 16, wherein the at least one of the computing modules is a server blade module.

18. The apparatus as in claim 5, wherein the at least one power input module is an AC power input module, and the power conversion modules are AC to DC power conversion modules.

19. The apparatus as in claim 18, wherein the computing modules comprise at least one of server blades, switches, fans, or management modules.

20. An apparatus for distributing power to computing modules in a multi module enclosure comprising:
means for receiving AC power from an AC facility power line, the means for receiving AC power modularly arranged within the multi module enclosure;
means for transferring power from the AC facility from the AC facility power line and providing power input to the means for receiving AC power;
means for converting the AC power from the means for receiving AC power to DC power, the means for converting the AC power modularly arranged within the multi module enclosure; and
means for performing computing receiving the DC power from the means for converting AC power, the means for performing computing arranged within the multi module enclosure.
